(19) United States
(12) Patent Application Publication
(10) Pub. No.: US 2022/0234232 A1
(43) Pub. Date: Jul. 28, 2022

(54) Spiralizer Device

(71) Applicant: ETN Capital, LLC, Sanford, NC (US)

(72) Inventors: Taylor Fife, Sanford, NC (US); Steven Ding, Huzhou (CN)

(21) Appl. No.: 17/161,117

(22) Filed: Jan. 28, 2021

(51) Int. Cl. B26D 3/11; B26D 7/26; B26D 7/06; B26D 3/26; B26D 1/43; B26D 1/00; A47J 43/07

(52) U.S. Cl. CPC B26D 3/11; B26D 7/2614; B26D 7/0641; B26D 3/26; B26D 2001/006; B26D 1/0006; A47J 43/0711; B26D 2210/02; B26D 1/43

(57) ABSTRACT

A spiralizing device that cuts vegetables into elongated strands. The spiralizing device includes a base that connects to a kitchen utensil, and a cutting blade for contacting the cutting the vegetables. The spiralizing device is an accessory that connects to and receives power from the kitchen utensil.

### TECHNICAL FIELD

The present application relates generally to kitchen appliances for cutting foods and, more particularly, to spiralizer devices for cutting vegetables into elongated strands.

### BACKGROUND

A spiralizer device is a kitchen appliance used for cutting vegetables into elongated strands. The spiralizing devices are configured to be used on a wide variety of vegetables, such as but not limited to zucchinis, potatoes, cucumbers, and carrots. The elongated strands often have a spiral shape which provides an aesthetically pleasing appearance as well as a functional shape for cooking.

A spiralizer device basically includes a base and a blade that rotates relative to the base. During use, a vegetable is positioned in the base and in contact against the blade. The blade is then rotated relative to the vegetable to cut the vegetable. The spiralizer device should be configured for the blade to smoothly rotate relative to the base for the vegetables to be cut into consistent and continuous strands. The spiralizer device should be constructed to prevent the cut vegetables from interfering with components that provide for rotation of the blade relative to the base. For example, gears and other like intermeshing components that provide for the relative rotation of the blade should be configured to prevent cut pieces of the vegetables from interfering with the operation.

It is necessary to regularly clean the spiralizer device after use. This removes pieces of the cut vegetables that remain on the device after cutting and ensures the spiralizer device is clean and ready for the next use. The spiralizer device should also be configured to be cleaned in a straight-forward manner. This includes providing access to the various surfaces of the base and blade to ensure that they are cleaned thoroughly. The design should prevent features that are difficult to access to remove the vegetable parts and/or to fully clean.

### SUMMARY

One aspect is directed to a spiralizer device configured to be powered by a kitchen utensil. The spiralizer device comprises a base comprising a body comprising an annular shape with a central opening, a mount that extends outward from the base to engage with the kitchen utensil, and a gear attached to the body and in contact with the mount with the gear configured to be rotated by the mount. A cutting member is sized to fit within the central opening and comprises a blade with an exposed cutting edge with the cutting member comprising teeth that engage with the gear to rotate the cutting member relative to the base.

In another aspect, the spiralizer device further comprises a chute having a cylindrical shape and a central passage with the chute configured to attach to the base with the central passage aligned with the central opening of the body.

In another aspect, the chute is a first chute and the central passage is a first central passage, and further comprising a second chute with a cylindrical body that is sized to fit within the first central passage of the first chute and comprising a second central passage comprising a smaller diameter than the first central passage.

In another aspect, the base, the cutting member, and the chute are coaxially aligned.

In another aspect, the base further comprises a bottom section, and a top section connected to the bottom section with the bottom and top sections forming an interior space with the gear positioned within the interior space.

In another aspect, the base further comprises an annular blade holder movably connected to the bottom section and the top section with the blade holder comprising teeth that engage with the gear to rotate relative to the bottom section and the top section.

In another aspect, the blade holder comprises a cylindrical shape with a central opening and with a shelf that extends into the central opening and the cutting member comprises a flange that seats against the shelf.

In another aspect, the cutting member comprises a tapered body with a slot that receives the blade.

In another aspect, the mount comprises an elongated shape with a first end that extends outward beyond the base and a second end that is positioned within the base with the first end comprising a polygonal sectional shape to engage with the kitchen utensil.

One aspect is directed to a spiralizer device configured to be powered by a kitchen utensil. The spiralizer device comprises a base comprising a first annular section, a second annular section positioned on the first annular section and comprising a set of teeth with the second annular section being rotatable relative to the first annular section, a central opening formed by the first annular section and the second annular section, a mount that extends outward from the first annular section to engage with the kitchen utensil, and a gear attached to the mount and comprising gear teeth that engage with the teeth on the second annular section. A cutting member is positioned in the central opening and comprises a blade with an exposed cutting edge with the cutting member engaged with the second annular section to rotate with the second annular section and relative to the first annular section.

In another aspect, the spiralizer device further comprises a chute with a cylindrical shape and a central passage with the chute configured to attach to the base with the central passage aligned with the central opening of the base.

In another aspect, the first annular section and the second annular section extend around and form an interior space and with the gear positioned within the interior space.

In another aspect, the first annular section, the second annular section, the cutting member, and the chute are co-axially aligned.

In another aspect, the cutting member comprises a tapered body.

One aspect is directed to a method of using a spiralizer device with a kitchen utensil. The method comprises: inserting a mount on the spiralizer device into a port on the kitchen utensil with the mount extending outward from a base of the spiralizer device with the base comprising an annular shape; rotating the mount and thereby rotating a holder relative to the base with the holder comprising an annular shape; rotating a cutting member that is positioned against the holder with the cutting member comprising a blade; and inserting a vegetable into a chute and against the cutting member and cutting the vegetable with the blade.

In another aspect, the method further comprises engaging teeth on the holder with a gear that is positioned on the mount and rotating the holder while rotating the mount.

In another aspect, the method further comprises inserting the cutting member into a central opening of the base and engaging ribs on the holder with ribs on the cutting member.

In another aspect, the method further comprises positioning a gear that is positioned on the mount and gear teeth on the holder within an interior space of the base and shielding the gear and the gear teeth.

In another aspect, the method further comprises attaching a cylindrical chute onto the base and aligning an input port in the chute with the cutting member.

In another aspect, the method further comprises inserting an additional cylindrical chute into the chute and reducing a size of the input port into the cutting member.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a perspective view of a spiralizer device attached to a kitchen utensil.

FIG. 2 is a perspective view of a spiralizer device.

FIG. 3 is a section view of the spiralizer device cut along line III-Ill of FIG. 2.

FIG. 4 is an exploded perspective view of a spiralizer device.

FIG. 5 is a perspective view of a blade holder.

FIG. 6 is a perspective view of a cutting member.

FIG. 7 is a perspective view of an outer chute member.

FIG. 8 is a perspective view of an outer chute member attached to a base.

FIG. 9 is a perspective view of an inner chute member.

FIG. 10 is a flowchart diagram of a method of using a spiralizer device with a kitchen utensil.

### DETAILED DESCRIPTION

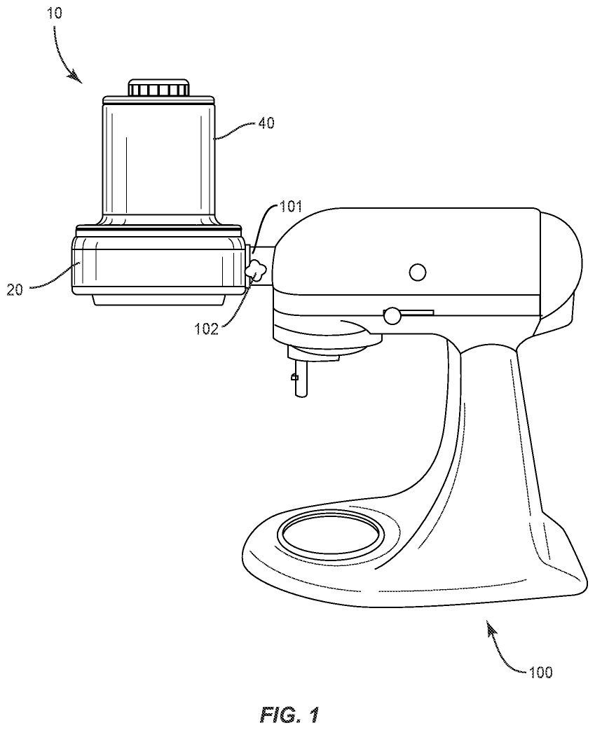

The present application is directed to a spiralizing device that cuts vegetables into elongated strands. The spiralizing device includes a base 20 that connects to a kitchen appliance 100, and a cutting member 30 for cutting the vegetables. As illustrated in FIG. 1, the spiralizing device 10 is an accessory that connects to and receives power from the kitchen appliance 100. In the example of FIG. 1, the kitchen appliance 100 is an electric mixer that includes a port 101 for receiving the spiralizing device 10. The spiralizing device 10 can also be used with various other types of kitchen appliances that include ports 101 for mounting.

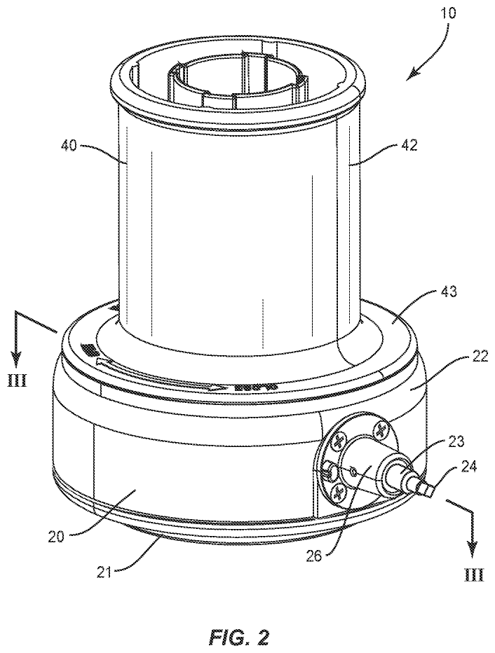

FIGS. 2, 3, and 4 illustrate an example of a spiralizing device 10 that includes the base 20, the cutting member 30, and the chute 40. The base 20 includes an annular shape with a central opening 66 for the vegetables to pass through during the cutting process. The base 20 includes a bottom section 21 and a top section 22 that are connected together by fasteners 90. Each of the bottom section 21 and top section 22 include annular shapes that together form the central opening 66. The bottom section 21 and top section 22 further form an interior space 69. The interior space 69 can be fully enclosed or include one or more openings.

A mount 23 is connected to and extends outward from one side of the base 20. The mount 23 includes an elongated shape with a first end 24 that is positioned radially outward beyond the base 20 and a second end 25 positioned within the interior space 69 of the base 20. In one example, the first end 24 includes a polygonal sectional shape to engage with the drive unit of the kitchen utensil 100 when the mount 24 is positioned within the port 101. A flange 26 is connected to an exterior of the base 20 and includes an opening through which the mount 23 extends. The flange 26 can include a neck that extends outward to engage with the port 101 of the kitchen utensil 100.

A gear 27 is attached to the mount 23. The gear 27 includes a central opening 29 that receives the mount 23 and teeth 28 that extend around a circular exterior. The gear 27 is attached to the mount 23 to rotate when the mount 23 is rotated by the kitchen utensil 100. The gear 27 is positioned within the interior space 69 of the base 20 to protect and shield the gear 27 from the cut vegetables and debris that can result from the cutting process.

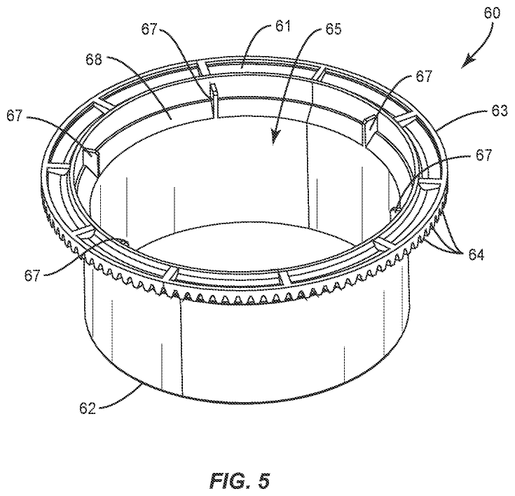

The base 20 also includes a blade holder 60 configured to receive the cutting member 30. FIG. 5 illustrates the blade holder 60 removed from the base 20. The blade holder 60 includes an annular shape with a top edge 61, bottom edge 62, and a central opening 65. A lip 63 extends around the periphery of the top edge 61 and includes teeth 64. The teeth 64 are aligned to face downward towards the bottom edge 62.

One or more ribs 67 are positioned along the inner side of the blade holder 60 and extend radially into the central opening 65. The ribs 67 can include various spacings and sizes. A shelf 68 also extends around the inner side of the blade holder 60 and is exposed around the central opening 65. In one example as illustrated in FIG. 5, the ribs 67 are positioned along the shelf 68.

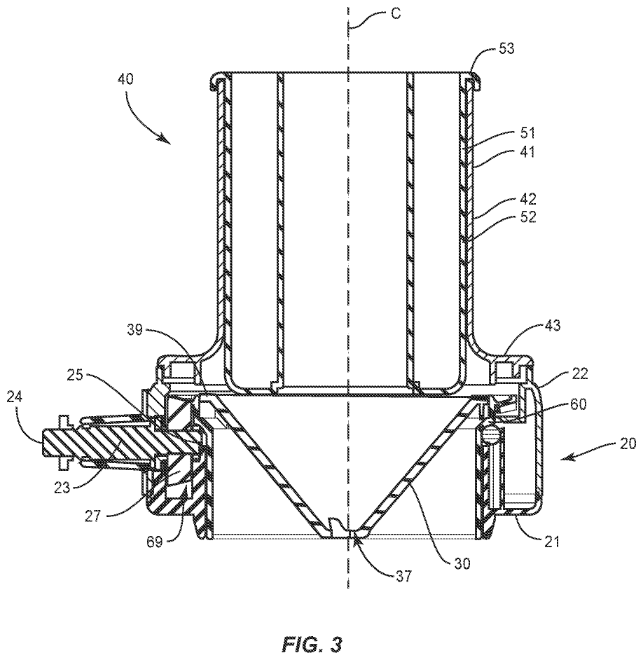

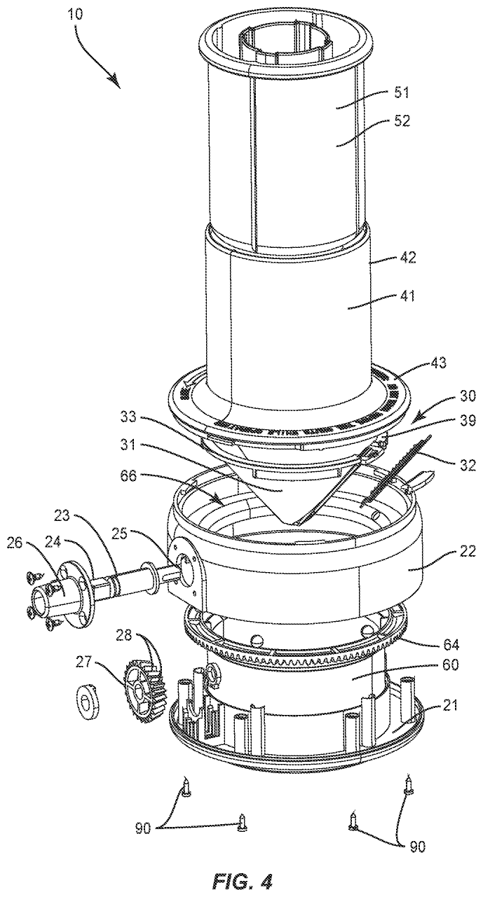

As illustrated in FIGS. 3 and 4, the blade holder 60 is co-axially aligned with the bottom and top sections 21, 22 of the base 20. The lip 63 is aligned for the teeth 64 to engage with the teeth 28 on the gear 27. Therefore, rotation of the mount 23 rotates the gear 27 which in turn rotates the blade holder 60. Thus, the blade holder 60 rotates relative to the bottom and top sections 21, 22 of the base 20. The teeth 64 and gear 27 are positioned in the interior space 69 formed by the bottom and top sections 21, 22 of the base 20. This protects these components and prevents and/or reduces debris from accumulating which could prevent rotation and/or efficiency of the rotation of the blade holder 60. In one example, the blade holder 60 fits within an opening formed between the bottom and top sections 21, 22 thus fully enclosing the interior space 69.

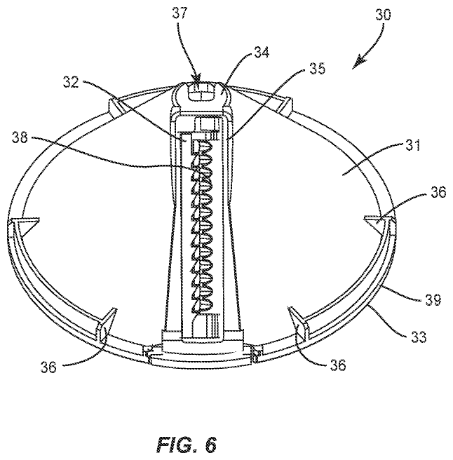

The cutting member 30 is sized and shape to engage with the blade holder 60. As illustrated in FIGS. 4 and 6, the cutting member 30 includes a body 31 and a blade 32. The body 31 has a tapered shape that reduces in size from a first end 33 to a second end 34. In one example, the body 31 includes a frusto-conical shape with a flat second end 34. A slot 35 extends through the body 31 and is sized to receive the blade 32. In one example, the slot 35 is perpendicular to the first end 33 and extends directly towards the second end 34. In one example as illustrated in FIG. 6, a single slot 35 extends through the body 31 to receive a single blade 32. In other examples, two or more slots 35 are positioned in the body 31 and each configured to receive a separate blade 32. The second end 34 includes an opening 37. The opening 37 provides for liquid or sections of the cut vegetables to pass through the cutting member 30.

The body 31 further includes a flange 39 at the first end 33. The flange 39 extends radially outward from the tapered surface and provides for engaging with the blade holder 60. In one example, the body 31 is sized to fit within the opening 65 of the blade holder 60. The flange 39 engages with the shelf 68 and positions the cutting member 30 in an axial position relative to the blade holder 60. One or more ribs 36 extend outward from the underside of the flange 39. The ribs 36 are configured to engage with the one or more ribs 67 on the blade holder 60. During rotation of the blade holder 60, the one or more ribs 67 engage with the one or more ribs 36. Thus, the rotation of the blade holder 60 rotates the cutting member 30.

The blade 32 is mounted in the slot 35. In one example as illustrated in FIG. 6, the blade 32 includes a rectangular shape with a cutting edge 38 exposed to contact against the vegetable. The blade 32 can include various shapes and configurations, including but not limited to a straight edge, serrated edge, and an edge with multiple teeth. The different shapes and configurations provide for cutting the vegetables in the desired shapes.

The chute 40 includes one or more chute members 41, 51. As illustrated in FIG. 3, the chute 40 is co-axially aligned with the base 20 and the cutting member 30.

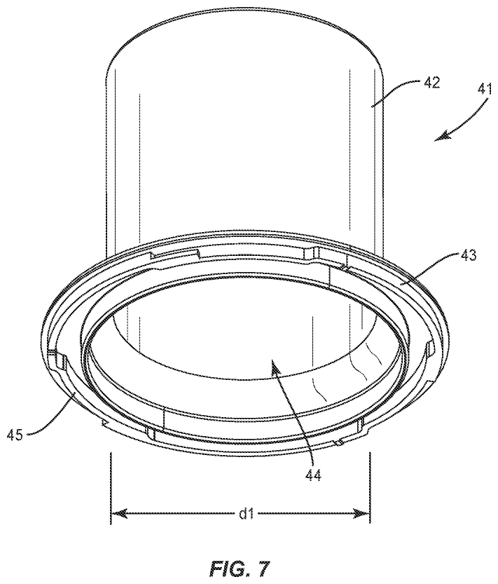

FIG. 7 illustrates the outer chute member 41 that is configured to engage with the base 20. The outer chute member 41 includes a cylinder section 42 and a flange 43. A central opening 44 extends through each of the cylinder section 42 and flange 43 and is sized to receive one or more vegetables. One or more extensions 45 extend outward from a lower side of the flange 43 and engage with the base 20. In one example, the extensions 45 are threads that engage with corresponding threads on the base 20 to secure the outer chute member 41 to the base 20.

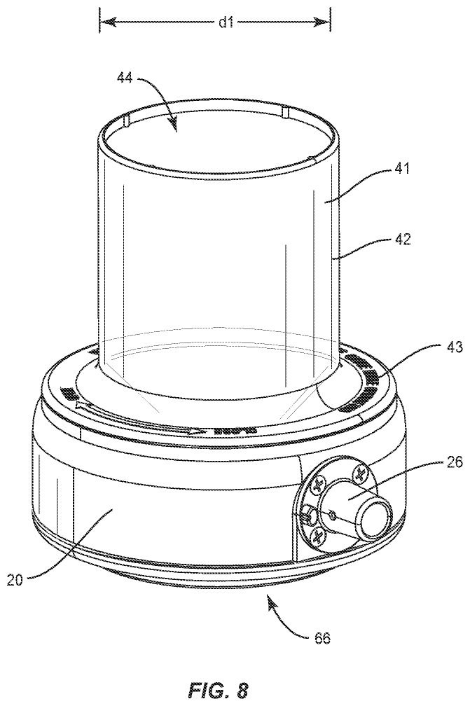

FIG. 8 illustrates the outer chute member 41 mounted to the base 20. The central opening 44 of the outer chute member 41 aligns with the central opening 66 of the base 20 and forms a single opening. The cylinder section 42 includes a first diameter d1 that is sized to receive vegetables of a first size. In one example, one or more sections of the outer chute member 41 are transparent to provide for a user to visually observe the vegetables.

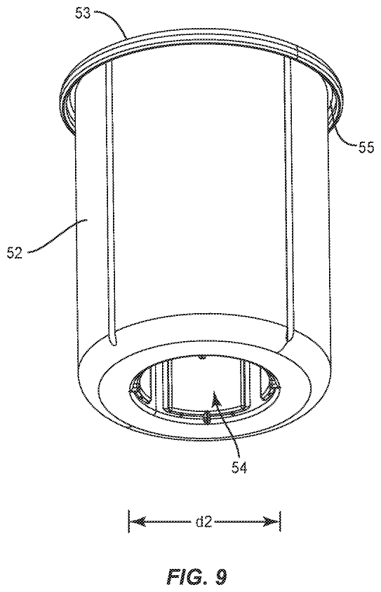

The inner chute member 51 is sized to engage with the outer chute member 41 to accommodate smaller vegetables. As illustrated in FIG. 9, the inner chute 51 includes a cylinder section 52 and a flange 53. An opening 54 extends through the inner chute member 51 and includes a second diameter d2 that is smaller than the first diameter d1 of the outer chute member 41. This smaller second diameter d2 accommodates smaller vegetables. Further, the outer diameter of the cylinder section 52 is smaller than the first diameter d1 to provide for the inner chute member 51 to fit within the central opening 44 of the outer chute member 41. The inner chute member 51 seats with the outer chute member 41 with the cylinder section 52 extending through the cylinder section 52 and the flange 53 contacting against the top edge. A gap 55 is formed between the edge of the flange 53 and the cylinder section 52. The gap 55 receives the upper edge of the cylinder section 42 when the inner chute member 51 is seated in the outer chute member 51.

The inner and outer chute members 51, 41 provide for accommodating different sizes of vegetables. For larger vegetables, the inner chute member 51 is removed and the vegetables are moved through the opening 44 of the outer chute member 41. For smaller vegetables, the inner chute member 51 is seated in the outer chute member 41 and the vegetables are moved through the opening 54 in the inner chute member 51.

The inner and outer chute members 51, 41 are sized to further accommodate a push stick that is used to move the vegetables into contact with the blade 32. The push stick can have an elongated shape with a length measured between opposing ends. The length of provides for a user to grasp the push stick near a first end and for the second end to be inserted into the chute 40 and contact against the vegetables. The user can apply a force to move the vegetables through the chute 40 and into contact with the blade 32. The push stick has an outer diameter sized to fit within the openings 44, 54 of each of the inner and outer chute members 51, 41.

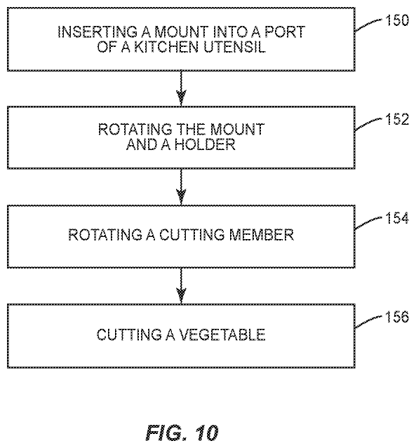

FIG. 10 illustrates a method of using a spiralizer device 10 with a kitchen utensil 100. This includes inserting a mount 23 on the spiralizer device 10 into a port 101 on the kitchen utensil 100 (block 150). The mount 23 extends outward from a base 20 of the spiralizer device 10 which facilitates the insertion into the port 101. The kitchen utensil 100 powers the spiralizer device 10 by rotating the mount 23. The spiralizer device 10 is configured to be supported by the kitchen utensil 100 when attached. In one example as illustrated in FIG. 1, a lock 102 on the spiralizer device 10 secures the spiralizer device 10 to the kitchen utensil 100. In one example, the lock 102 includes a threaded bolt that extends through an opening on the flange 26 and mates with the kitchen utensil 100.

With the spiralizer device 10 connected to the kitchen utensil 100, the kitchen utensil 100 provides power to rotate the mount 23 thereby rotating a holder (block 152). The rotating holder 60 is engaged with a cutting member 30 that includes a blade 32. The rotation of the holder 60 rotates the cutting member 30 (block 154). With the cutting member 30 rotating, a vegetable is moved into contact against the cutting member 30 and the vegetable is cut (block 156).

The spiralizer device 10 can be constructed from a variety of different materials. Materials includes but are not limited to plastics and metals. The different components of the spiralizer device 10 can be constructed from the same or different materials. In one example, the base bottom and top sections 21, 22, the blade holder 60, and cutting member body 31, outer chute 41, and inner chute 51 are constructed from plastic including the gear 27 and the teeth 64 of the blade holder 60, and the blade 32 is constructed from metal. In one example, just the blade 32 and the mount 23 are constructed from metal and the other components are constructed from plastic. In another example, just the blade 32 is constructed from metal with the other components constructed from plastic.

The spiralizer device 10 is configured to cut vegetables into elongated strands. The spiralizer device 10 can also be used to cut other items.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A spiralizer device configured to be powered by a kitchen utensil, the spiralizer device comprising:
a base comprising:
a body comprising an annular shape with a central opening;
a mount that extends outward from the base to engage with the kitchen utensil;
a gear attached to the body and in contact with the mount, the gear configured to be rotated by the mount; and
a cutting member sized to fit within the central opening and comprising a blade with an exposed cutting edge, the cutting member comprising teeth that engage with the gear to rotate the cutting member relative to the base.

2. The spiralizer device of claim 1, further comprising a chute having a cylindrical shape and a central passage, the chute configured to attach to the base with the central passage aligned with the central opening of the body.

3. The spiralizer device of claim 2, wherein the chute is a first chute and the central passage is a first central passage, and further comprising a second chute with a cylindrical body that is sized to fit within the first central passage of the first chute and comprising a second central passage comprising a smaller diameter than the first central passage.

4. The spiralizer device of claim 2, wherein the base, the cutting member, and the chute are coaxially aligned.

5. The spiralizer device of claim 1, wherein the base further comprises:
a bottom section; and
a top section connected to the bottom section that forms an interior space with the gear positioned within the interior space.

6. The spiralizer of claim 5, wherein the base further comprises an annular blade holder movably connected to the bottom section and the top section, the blade holder comprising teeth that engage with the gear to rotate relative to the bottom section and the top section.

7. The spiralizer device of claim 6, wherein the blade holder comprises a cylindrical shape with a central opening and with a shelf that extends into the central opening, and the cutting member comprises a flange that seats against the shelf.

8. The spiralizer device of claim 1, wherein the cutting member comprises a tapered body with a slot that receives the blade.

9. The spiralizer device of claim 1, wherein the mount comprises an elongated shape with a first end that extends outward beyond the base and a second end that is positioned within the base, the first end comprising a polygonal sectional shape to engage with the kitchen utensil.

10. A spiralizer device configured to be powered by a kitchen utensil, the spiralizer device comprising:
a base comprising:
a first annular section;
a second annular section positioned on the first annular section and comprising a set of teeth, the second annular section being rotatable relative to the first annular section;
a central opening formed by the first annular section and the second annular section;
a mount that extends outward from the first annular section to engage with the kitchen utensil;
a gear attached to the mount and comprising gear teeth that engage with the teeth on the second annular section; and
a cutting member positioned in the central opening and comprising a blade with an exposed cutting edge, the cutting member engaged with the second annular section to rotate with the second annular section and relative to the first annular section.

11. The spiralizer device of claim 10, further comprising a chute with a cylindrical shape and a central passage, the chute configured to attach to the base with the central passage aligned with the central opening of the base.

12. The spiralizer device of claim 10, wherein the first annular section and the second annular section extend around and form an interior space and with the gear positioned within the interior space.

13. The spiralizer device of claim 12, wherein the first annular section, the second annular section, the cutting member, and the chute are co-axially aligned.

14. The spiralizer of claim 10, wherein the cutting member comprises a tapered body.

15. A method of using a spiralizer device with a kitchen utensil, the method comprising:
inserting a mount on the spiralizer device into a port on the kitchen utensil with the mount extending outward from a base of the spiralizer device with the base comprising an annular shape;
rotating the mount and thereby rotating a holder relative to the base with the holder comprising an annular shape;
rotating a cutting member that is positioned against the holder with the cutting member comprising a blade; and
inserting a vegetable into a chute and against the cutting member and cutting the vegetable with the blade.

16. The method of claim 15, further comprising engaging teeth on the holder with a gear that is positioned on the mount and rotating the holder while rotating the mount.

17. The method of claim 15, further comprising inserting the cutting member into a central opening of the base and engaging ribs on the holder with ribs on the cutting member.

18. The method of claim 15, further comprising positioning a gear that is positioned on the mount and gear teeth on the holder within an interior space of the base and shielding the gear and the gear teeth.

19. The method of claim 15, further comprising attaching a cylindrical chute onto the base and aligning an input port in the chute with the cutting member.

20. The method of claim 19, further comprising inserting an additional cylindrical chute into the chute and reducing a size of the input port into the cutting member.
